(19) United States
(12) Patent Application Publication
(10) Pub. No.: US 2003/0174513 A1
(43) Pub. Date: Sep. 18, 2003

(54) Luminaire having an optical conductor and a plurality of light sources

(75) Inventors: Matthias Fiegler, Heidenheim (DE); Thomas Reiners, Bachhagel (DE)

Correspondence Address: OSRAM SYLVANIA INC, 100 ENDICOTT STREET, DANVERS, MA, 01923, US

(73) Assignee: PATENT-TREUHAND-GESELLSCHAFT FUR ELEKTRISCHE GLUHL, Munchen (DE)

(21) Appl. No.: 10/386,450

(22) Filed: Mar. 13, 2003

(30) Foreign Application Priority Data
Mar. 13, 2002 (DE) 202 04 102.6

(51) Int. Cl. B60Q 1/26; F21V 5/00

(52) U.S. Cl. 362/541; 362/246; 362/245

(57) ABSTRACT

A luminaire having a light source, an optical conductor with a light exit surface that is optically coupled to the light source, and operating elements for the light source. A plurality of further light sources are provided to which the optical conductor is optically coupled. The light sources have an essentially punctiform light emission characteristic, and the light exit surface is designed to scatter light diffusely, and the other outer surfaces, not serving for launching light, of the optical conductor are designed to be totally reflecting or in a silvered fashion.

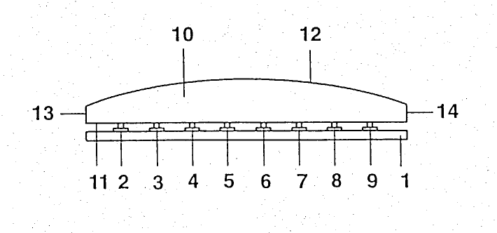

### I. TECHNICAL FIELD

The invention relates to a luminaire having a light source, an optical conductor with a light exit surface that is optically coupled to the light source, and operating means for the light source.

### II. BACKGROUND ART

Such a luminaire is disclosed in the laid-open patent application DE 199 23 919. This document describes a motor vehicle luminaire having a light source, operating means for the light source and at least one optical conductor that is optically coupled to the light source and whose light exit surface is matched to the contour of the motor vehicle.

### III. DISCLOSURE OF THE INVENTION

It is the object of the invention to provide a luminaire having an optical conductor and which emits light as homogeneously as possible.

This object is achieved according to the invention by means of a luminaire having a light source, an optical conductor with a light exit surface that is optically coupled to the light source, and operating means for the light source, wherein a plurality of further light sources are provided to which the optical conductor is optically coupled, the light sources have an essentially punctiform light emission characteristic, and the light exit surface is designed to scatter light diffusely, and the other outer surfaces, not serving for launching light, of the optical conductor are designed to be totally reflecting or in a silvered fashion.

Particularly advantageous designs of the invention are described in the subclaims.

The luminaire according to the invention has a plurality of light sources with an essentially punctiform light emission characteristic, operating means for the light sources and an optical conductor with a light exit surface designed to scatter light diffusely, and whose other outer surfaces, not serving for launching light, are designed to be totally reflecting or in a silvered fashion, and which is coupled optically to the light sources. These features or measures ensure that the luminaire emits light homogeneously. In particular, the light exit surface of the optical conductor appears to be illuminated with uniform brightness.

It is advantageous to use cost effective light-emitting diodes as light sources. A Fresnel-type optical system is advantageously provided in order to launch into the optical conductor as large as possible a fraction of the light generated by the light-emitting diodes. The luminaire according to the invention is preferably designed as a brake luminaire arranged in the region of the rear window of a motor vehicle.

### IV. BEST MODE FOR CARRYING OUT THE INVENTION

The invention is explained in more detail below with the aid of a preferred exemplary embodiment.

The figure shows a schematic representation of the principle of the luminaire according to the invention. This luminaire has eight light-emitting diodes 2-9, which are mounted on a printed circuit board 1 and emit red light, and an optical conductor 10 made from transparent plastic. The light-emitting diodes 2-9 are arranged equidistantly in a row on the printed circuit board 1. The light generated by them is launched into the flat end face 11 of the optical conductor 10 via a Fresnel optical system (not illustrated) in each case. The opposite end face 12 is cambered and designed as a light exit surface that scatters light diffusely. For this purpose, the light exit surface 12 can be roughened or provided with microprisms. The two outer side faces 13, 14 are designed in a silvered fashion such that the light striking them is retroreflected into the optical conductor 10 and must leave it via the end face 12. The camber of the end face 12 is matched to the contour of the rear window of a motor vehicle, in order to be able to use the luminaire as a high level brake light. The light emitting diodes 2-9 are operated by means of a driver circuit (not illustrated) fed from the motor vehicle network.

What is claimed is:

1. A luminaire having a light source, an optical conductor with a light exit surface that is optically coupled to said light source, and operating means for the light source, wherein
a plurality of further light sources are provided to which said optical conductor is optically coupled,
said light sources have an essentially punctiform light emission characteristic, and
said light exit surface is designed to scatter light diffusely, and the other outer surfaces, not serving for launching light, of said optical conductor are designed to be totally reflecting or in a silvered fashion.

2. The luminaire as claimed in claim 1, wherein the light sources are light-emitting diodes.

3. The luminaire as claimed in claim 2, wherein a Fresnel-type optical system is provided for launching light.

4. A motor vehicle brake luminaire as claimed in claim 1.
